(19) United States
(12) Patent Application Publication
(10) Pub. No.: US 2013/0272518 A1
(43) Pub. Date: Oct. 17, 2013

(54) SPEECH ENCRYPTION METHOD AND DEVICE, SPEECH DECRYPTION METHOD AND DEVICE

(71) Applicant: BLUCRYPT TECHNOLOGIES INC., Tortola (VG)

(72) Inventors: Meng-Tse Wu, Taipei City (TW); Chia-Lung Ma, Taipei City (TW); Chin-Yuan Chen, New Taipei City (TW)

(73) Assignee: BLUCRYPT TECHNOLOGIES INC., Tortola (VG)

(21) Appl. No.: 13/713,494

(22) Filed: Dec. 13, 2012

(30) Foreign Application Priority Data
Apr. 11, 2012 (TW) 101112797

(51) Int. Cl. H04L 9/08

(52) U.S. Cl. CPC H04L 9/0861
USPC 380/44

(57) ABSTRACT

A speech encryption method for encrypting a digital speech signal includes the steps of generating an encryption key, deriving a plurality of voice feature data from the digital speech signal, determining a corresponding shift parameter according to the encryption key and converting the voice feature data derived therefrom into converted speech data based on the shift parameter, and determining corresponding dual-tone multi-frequency (DTMF) data according to the encryption key and interleaving the DTMF data with the converted speech data so as to obtain a scrambled speech signal.

### CROSS-REFERENCE TO RELATED APPLICATION

This application claims priority of Taiwanese Patent Application No. 101112797, filed on Apr. 11, 2012.

### BACKGROUND OF THE INVENTION

1. Field of the Invention

The present invention relates to an encryption method, more particularly to a speech encryption method and device, and a speech decryption method and device capable of preserving voice features of a speech signal and scrambling the speech signal for secure voice communication.

2. Description of the Related Art

At present, when mobile communication devices are utilized for conversation, a speech signal inputted via the mobile communication device at a transmitter side is usually compressed thereby, and is decompressed correspondingly via the mobile communication device at a receiver side so as to recover the speech signal.

Code-excited linear prediction (CELP) is a common speech coding technique for data compression of digital audio signals. Due to relatively low complexity in algorithm and relatively good speech preservation quality, CELP has been widely adopted for design of speech encoders and speech decoders. Technology relevant to a CELP encoder may be found in U.S. Pat. No. 5,414,796.

However, CELP technique is designed for digital audio signals. If a conversation conducted using an analog speech signal is desired to be kept secret and not be wiretapped during transmission, non-speech information is usually added to the analog speech signal so as to form a scrambled speech signal. Since the scrambled speech signal includes non-speech information, a speech signal recovered from the scrambled speech signal that has gone through CELP compression/decompression may have relatively poor quality.

### SUMMARY OF THE INVENTION

Therefore, an object of the present invention is to provide a speech encryption method and device, and a speech decryption method and device capable of preserving voice features of a speech signal and scrambling the speech signal for secure voice communication.

In a first aspect of the present invention, a speech encryption method is to be implemented by an encryption device for encrypting a digital speech signal, and comprises the steps of:

(A) configuring the encryption device to generate an encryption key;

(B) configuring the encryption device to derive a plurality of voice feature data from the digital speech signal;

(C) configuring the encryption device to determine a corresponding shift parameter according to the encryption key generated thereby, and to convert the voice feature data derived therefrom into converted speech data based on the shift parameter; and

(D) configuring the encryption device to determine corresponding dual-tone multi-frequency (DTMF) data according to the encryption key generated thereby, and to interleave the DTMF data with the converted speech data so as to obtain a scrambled speech signal.

In a second aspect of the present invention, a speech decryption method is to be implemented by a decryption device for decrypting a scrambled speech signal obtained using the above-mentioned speech encryption method, and comprises the steps of:

(i) configuring the decryption device to parse the scrambled speech signal into dual-tone multi-frequency (DTMF) data and converted speech data;

(ii) configuring the decryption device to determine a shift parameter according to the DTMF data;

(iii) configuring the decryption device to recover a plurality of voice feature data from the converted speech data based on the shift parameter; and

(iv) configuring the decryption device to synthesize the voice feature data recovered thereby so as to obtain a digital speech signal.

In a third aspect of the present invention, a speech encryption device is for encrypting a digital speech signal, and comprises a first synchronous processing module, a first speech analysis module and an encryption module. The first synchronous processing module is configured to generate an encryption key, and to determine a corresponding shift parameter according to the encryption key. The first speech analysis module is coupled electrically to the first synchronous processing module, and is configured to derive a plurality of voice feature data from the digital speech signal, and to convert the voice feature data into converted speech data based on the shift parameter. The encryption module is coupled electrically to the first synchronous processing module and the first speech analysis module, and is configured to determine corresponding dual-tone multi-frequency (DTMF) data according to the encryption key, and to interleave the DTMF data with the converted speech data so as to obtain a scrambled speech signal.

In a fourth aspect of the present invention, a speech decryption device is for decrypting a scrambled speech signal obtained using the above-mentioned speech encryption device, and comprises a decryption module, a second synchronous processing module and a second speech analysis module. The decryption module is configured to parse the scrambled speech signal into dual-tone multi-frequency (DTMF) data and converted speech data. The second synchronous processing module is coupled electrically to the decryption module and is configured to determine a shift parameter according to the DTMF data. The second speech analysis module is coupled electrically to the decryption module and the second synchronous processing module, and is configured to recover a plurality of voice feature data from the converted speech data based on the shift parameter, and to synthesize the voice feature data recovered thereby so as to obtain a digital speech signal.

An effect of the present invention resides in that, by virtue of deriving the plurality of voice feature data, converting the voice feature data based on the shift parameter and interleaving the DTMF data with the converted speech data, the scrambled speech signal, which contains preserved voice feature data and which is substantially unintelligible when intercepted, may be obtained so as to prevent compression damage and deter phone tapping.

### BRIEF DESCRIPTION OF THE DRAWINGS

Other features and advantages of the present invention will become apparent in the following detailed description of two preferred embodiments with reference to the accompanying drawings, of which:

FIG. 1 is a block diagram illustrating a speech security system including a speech encryption device and a speech decryption device of the present invention;

FIG. 2 is a flow chart illustrating a preferred embodiment of a speech encryption method according to the present invention;

FIG. 3 is a block diagram illustrating a first preferred embodiment of the speech encryption device according to the present invention;

FIG. 4 is a schematic diagram illustrating formats of a digital speech signal and a scrambled speech signal in the first preferred embodiment;

FIG. 5 is a flow chart illustrating a preferred embodiment of a speech decryption method according to the present invention;

FIG. 6 is a block diagram illustrating a first preferred embodiment of the speech decryption device corresponding to the speech encryption device according to the present invention;

FIG. 7 is a block diagram illustrating a second preferred embodiment of the speech encryption device according to the present invention;

FIG. 8 is a schematic diagram illustrating formats of a digital speech signal and a scrambled speech signal in the second preferred embodiment; and

FIG. 9 is a block diagram illustrating a second preferred embodiment of the speech decryption device corresponding to the speech encryption device according to the present invention.

### DETAILED DESCRIPTION OF THE PREFERRED EMBODIMENTS

Before the present invention is described in greater detail with reference to the preferred embodiments, it should be noted that the same reference numerals are used to denote the same elements throughout the following description.

It is noted that, in practice, a design of the present invention may be implemented through one of software (i.e., program coding on different operating system platforms, such as WindowsMobile, iOS, Android, Symbian, etc.), hardware (such as an application-specified IC, microelectronic circuits, etc.), firmware (such as program coding on a micro processor, a digital signal processor, etc.), and combination of at least two of the aforementioned schemes.

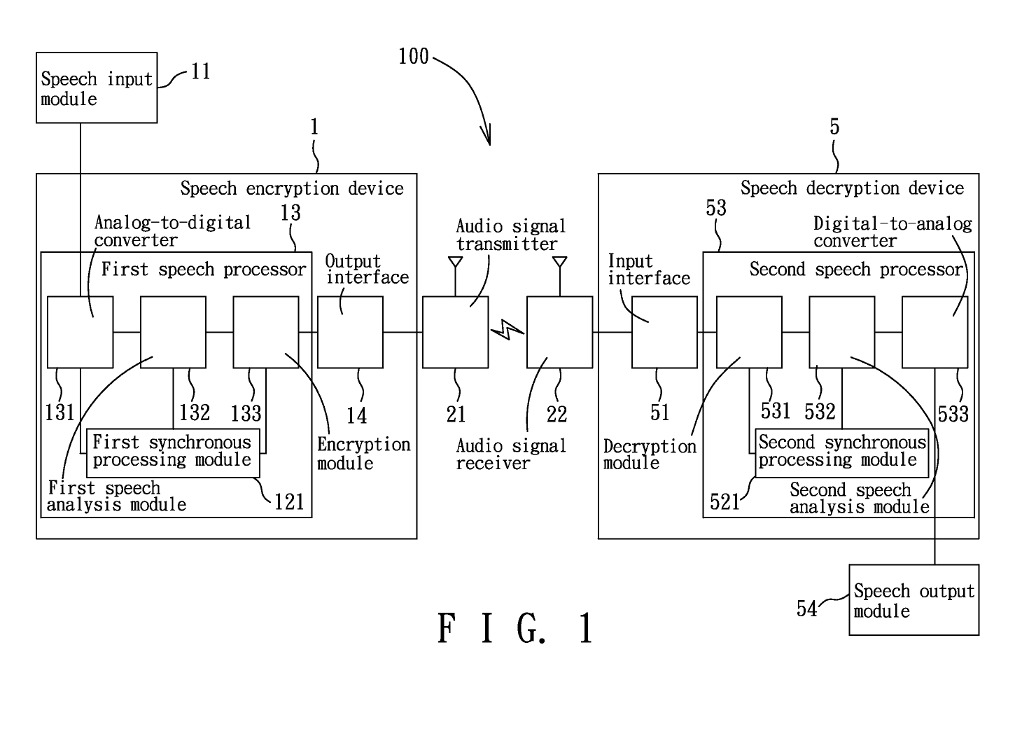

Referring to FIG. 1, a speech security system 100 including first preferred embodiments of a speech encryption device 1 and a speech decryption device 5 according to the present invention is illustrated. The speech encryption device 1 is to be utilized in combination with a speech input module 11 (such as a microphone) and an audio signal transmitter 21. The speech decryption device 5 is to be utilized in combination with an audio signal receiver 22 for receiving an output signal transmitted by the audio signal transmitter 21, and a speech output module 54 (such as an earphone, a speaker, etc.) for output of audio signals.

The speech encryption device 1 comprises a first speech processor 13 and an output interface 14. The output interface 14 is a wired/wireless transmitting module capable of transmitting an output signal from the first speech processor 13 to the audio signal transmitter 21.

In this embodiment, the audio signal transmitter 21 and the audio signal receiver 22 are mobile communication devices which may communicate with each other via wireless communication technology, such as WCDMA, CDMA 2000, or GSM. Alternatively, the audio signal transmitter 21 and the audio signal receiver 22 may be implemented via wired communication, such as a landline telephone.

The first speech processor 13 of the speech encryption device 1 includes an analog-to-digital converter 131, a first speech analysis module 132, an encryption module 133, and a first synchronous processing module 121.

The analog-to-digital converter 131 is configured to convert an analog speech signal that is received from the speech input module 11 into a digital speech signal, and to send the digital speech signal to the first speech analysis module 132.

The first synchronous processing module 121 is configured to generate an encryption key, and to determine a corresponding shift parameter according to the encryption key. In this embodiment, the shift parameter is determined based on a look-up table. Alternatively, logic operations (such as XOR) may be adopted for determining the shift parameter. It is noted that a number of the shift parameter is not limited to one, and a plural of the shift parameters may be determined by the first synchronous processing module 121.

The first speech analysis module 132 is coupled electrically to the analog-to-digital converter 131 and the first synchronous processing module 121, and is configured to derive a plurality of voice feature data from the digital speech signal converted by the analog-to-digital converter 131, and to convert the voice feature data into converted speech data based on the shift parameter determined by the first synchronous processing module 121.

The encryption module 133 is coupled electrically to the first synchronous processing module 121 and the first speech analysis module 132, and is configured to determine corresponding dual-tone multi-frequency (DTMF) data according to the encryption key generated by the first synchronous processing module 121, and to interleave the DTMF data with the converted speech data that is converted by the first speech analysis module 132 so as to obtain a scrambled speech signal which is subsequently transmitted to the audio signal transmitter 21 via the output interface 14. In this embodiment, the DTMF data is determined based on a DTMF look-up table. Alternatively, logic operations may be adopted for determining the DTMF data.

The feature of the speech encryption device 1 according to the present invention resides in that the scrambled speech signal includes the converted speech data and the DTMF data. In a conventional telephone system, DTMF signaling is configured for controlling communications between a telephone set and a switching center, and is usually utilized for transmission of numbers dialed through a telephone keypad. A DTMF signal is a mixture of a lower frequency sine wave signal and a higher frequency sine wave signal. For example, the DTMF signal representing the number of “7” is a mixture of 852 Hz and 1209 Hz sine wave signals. The switching center may determine which key was dialed through decoding the mixture of the frequencies of the sine wave signals.

Referring to the Table depicted below, a standard keypad is taken as an example in which sixteen dual tone signals are defined for DTMF signaling.

TABLE

| | 1209 Hz | 1336 Hz | 1477 Hz | 1633 Hz |
|---|---|---|---|---|
| 697 Hz | 1 | 2 | 3 | A |
| 770 Hz | 4 | 5 | 6 | B |
| 852 Hz | 7 | 8 | 9 | C |
| 941 Hz | * | 0 | # | D |

It is noted that this table is only an exemplary implementation of the DTMF signals. In practice, custom formats of DTMF signaling may be adopted, as long as each of the DTMF signals is the mixture of a lower frequency sine wave signal and a higher frequency sine wave signal.

The decryption device 5 comprises an input interface 51 for receiving an output signal from the audio signal receiver 22, and a second speech processor 53. In this embodiment, the output signal from the audio signal receiver 22 is the scrambled speech signal outputted from the speech encryption device 1, and the decryption device 5 is adapted for decrypting the scrambled speech signal obtained using the speech encryption device 1.

The second speech processor 53 of the speech decryption device 5 includes a decryption module 531, a second synchronous processing module 521 that corresponds to the first synchronous processing module 121 for enabling synchronous encryption and decryption at a transmitter end and a receiver end respectively, a second speech analysis module 532, and a digital-to-analog converter 533.

The decryption module 531 is configured to parse the scrambled speech signal into the DTMF data and the converted speech data. The second synchronous processing module 521 is coupled electrically to the decryption module 531 and is configured to determine the shift parameter according to the DTMF data based on a look-up table. Alternatively, the shift parameter may be determined according to the DTMF data based on logic operations. The second speech analysis module 532 is coupled electrically to the decryption module 531 and the second synchronous processing module 521, and is configured to recover a plurality of voice feature data from the converted speech data based on the shift parameter, and to synthesize the voice feature data recovered thereby so as to obtain a recovered digital speech signal. The digital-to-analog converter 533 is coupled electrically to the second speech analysis module 532 for converting the recovered digital speech signal into a recovered analog speech signal which is to be transmitted to the speech output module 54 for subsequent reproduction.

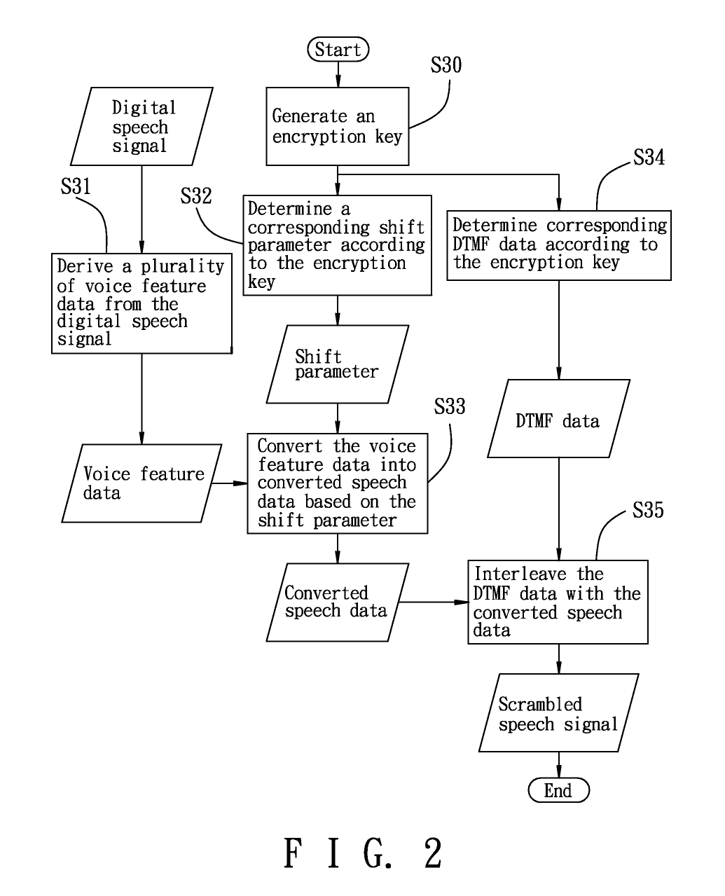

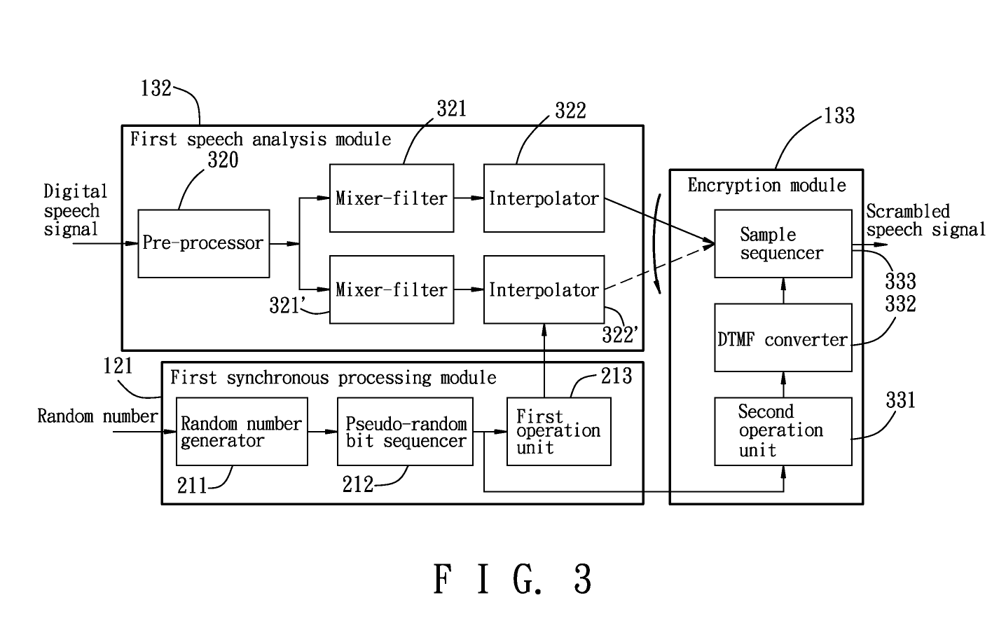

Referring to FIG. 2 and FIG. 3, a preferred embodiment of a speech encryption method to be implemented by the speech encryption device 1, according to the present invention, comprises the following steps.

In step S30, the speech encryption device 1 is configured to generate an encryption key. In practice, referring to FIG. 3, the first synchronous processing module 121 includes a random number generator 211, a pseudo-random bit sequencer (PRBS) 212 and a first operation unit 213. In this embodiment, the random number generator 211 receives a random number, which comes from the speech input module 11 and is regarded as a seed, so as to generate random numbers. Subsequently, the PRBS 212 generates the encryption key according to the random numbers generated by the random number generator 211. It is noted that the encryption key is preferably a time-varying encryption key for promoting the degree of secrecy of the scrambled speech signal obtained using the speech encryption method according to the present invention. Since generation of an encryption key may be readily appreciated by those skilled in the art, further details of the same are omitted herein for the sake of brevity.

In step S31, the speech encryption device 1 is configured to derive a plurality of voice feature data from the digital speech signal. In practice, referring to FIG. 3, the first speech analysis module 132 includes a pre-processor 320, a pair of mixer-filters 321, 321′ which correspond to different frequency ranges (for example, the frequency ranges of human voice, such as 0 to 1.5 KHz, and 1.5 KHz to 3 KHz) for frequency shift operations and filter operations, and a pair of interpolators 322, 322′ coupled electrically and respectively to the mixer-filters 321, 321′.

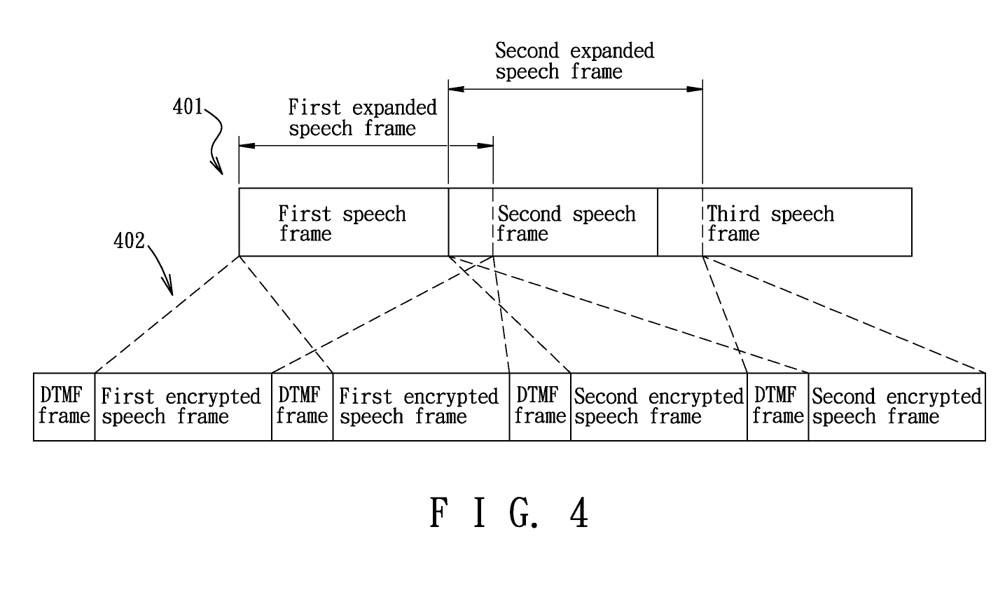

Referring to FIG. 4, for the purpose of maintaining speech quality, prior to the mixer-filters 321, 321′, the pre-processor 320 is configured to divide the digital speech signal 401 into a plurality of speech frames, and to form expanded speech frames from the speech frames. In this embodiment, each of the expanded speech frames is formed by attaching, to a respective one of the speech frames, a segment of one of the speech frames adjacent to the respective one of the speech frames. For example, the plurality of speech frames may be a first speech frame (How), a second speech frame (are), and a third speech frame (You). The expanded speech frames may be a first expanded speech frame (Howa), a second expanded speech frame (arey), and a third expanded speech frame (You).

The mixer-filters 321, 321′ are configured to derive the voice feature data from the expanded speech frames. In this embodiment, the mixer-filters 321, 321′ shift different frequency components of each of the expanded speech frames to baseband, and filter the shifted frequency components of each of the expanded speech frames so as to derive the plurality of voice feature data.

In step S32, the speech encryption device 1 is configured to determine a corresponding shift parameter according to the encryption key generated thereby. In practice, referring to FIG. 3, the first operation unit 213 of the first synchronous processing module 121 stores a built-in parameter look-up table, and uses the encryption key generated by the PRBS 212 as an index to look up the parameter look-up table so as to determine the corresponding shift parameter. In this embodiment, the shift parameter is a downsampling factor.

In step S33, the speech encryption device 1 is configured to convert the voice feature data derived thereby into converted speech data based on the shift parameter. In practice, referring to FIG. 3, the interpolators 322, 322′ downsample the voice feature data based on the shift parameter so as to obtain the converted speech data. It is noted that the interpolators 322, 322′ may change a rate of downsampling applied to the plurality of voice feature data along with variation of the encryption key. Since the lower the rate of downsampling is, the higher pitch the result of downsampling will have, the pitch of the converted speech data outputted from the interpolators 322, 322′ may change over time.

In step S34, the speech encryption device 1 is configured to determine corresponding DTMF data according to the encryption key generated thereby. In practice, referring to FIG. 3, the encryption module 133 includes a second operation unit 331, a DTMF converter 332 and a sample sequencer 333. The second operation unit 331 stores the built-in DTMF look-up table, and uses the encryption key generated by the PRBS 212 as an index to look up the DTMF look-up table for obtaining corresponding dual-tone sounds. The DTMF converter 332 converts the dual-tone sounds into the corresponding DTMF data.

In step S35, the speech encryption device 1 is configured to interleave the DTMF data with the converted speech data so as to obtain a scrambled speech signal. In practice, referring to FIG. 3, the sample sequencer 333 is coupled electrically to the DTMF converter 332 and the interpolators 322, 322′, receives respectively the DTMF data and the converted speech data, and interleaves the DTMF data with the converted speech data so as to output the scrambled speech signal. At this time, when the scrambled speech signal is intercepted by a third party, only an unintelligible sound of the dual-tone sounds interleaved with pitch-fluctuating noise would be heard.

Referring once again to FIG. 4, the format of the scrambled speech signal 402 includes a plurality of encrypted speech frames that are associated respectively with the converted speech data, and DTMF frames that are associated respectively with the DTMF data. The DTMF frames are formed by the sample sequencer 333 from the DTMF data during interleaving the DTMF data with the converted speech data. It is noted that each of the expanded speech frames corresponds to a pair of the encrypted speech frames since the first speech analysis module 132 includes the pair of mixer-filters 321, 321′. Content of each of the encrypted speech frames includes a fragmentary content of a respective one of the expanded speech frames. Aside from achieving an effect of scrambling the converted speech data, the DTMF frames are interleaved with encrypted speech frames for another reason: since a data size of the voice feature data decreases as a result of downsampling, the converted speech data should be supplemented with the DTMF data such that the scrambled speech signal 402 may have a data size similar to that of the original digital speech signal 401. In this way, a subsequent recovery process associated with the scrambled speech signal may be implemented with speed, and data loss may be prevented during the recovery process.

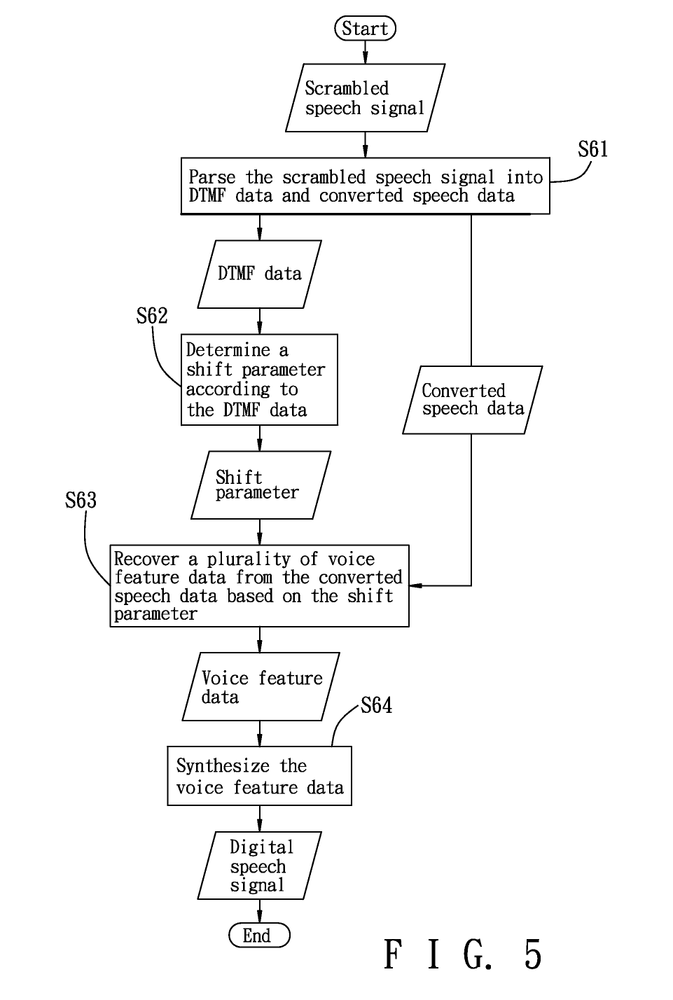

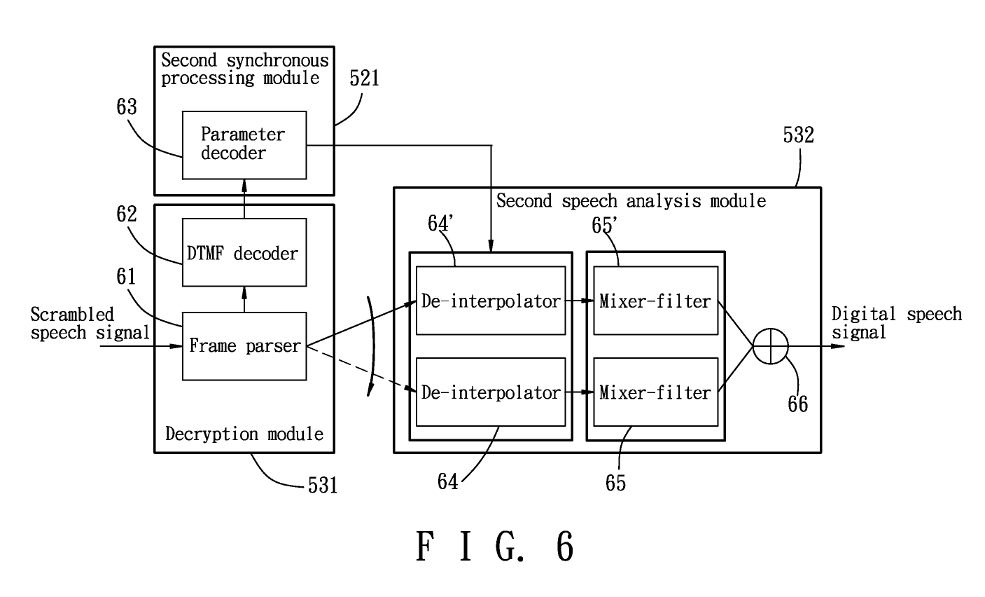

Referring to FIG. 5 and FIG. 6, a first preferred embodiment of the speech decryption device 5 corresponding to the speech encryption device 1, and a speech decryption method to be implemented by the speech decryption device 5, according to the present invention, are illustrated.

In step S61, the decryption device 5 is configured to parse the scrambled speech signal into DTMF data and converted speech data. In practice, referring to FIG. 6, the decryption module 531 includes a frame parser 61 and a DTMF decoder 62. The frame parser 61 determines position information of the DTMF frames in the scrambled speech signal, and separates the DTMF frames from the scrambled speech signal. It is noted the position information is added to the DTMF frames when the sample sequencer 333 forms the DTMF frames. The DTMF decoder 62 receives the DTMF frames from the frame parser 61, and decodes the DTMF frames so as to obtain the DTMF data. The remainder of the scrambled speech signal with the DTMF frames separated therefrom is the converted speech data.

In step S62, the speech decryption device 5 is configured to determine a shift parameter according to the DTMF data. In practice, referring to FIG. 6, the second synchronous processing module 521 includes a parameter decoder 63. The parameter decoder 63 stores a built-in look-up table, and uses the DTMF data decoded by the DTMF decoder 62 as an index to lookup the look-up table so as to determine the corresponding shift parameter directly which is then sent to the second speech analysis module 532. Alternatively, in an indirect way, the encryption key is first determined according to the DTMF data, and then the encryption key is utilized for determining the shift parameter. It is noted that the way for determining the shift parameter is not limited to the look-up table, and logic operations, such as predetermined logic operators, may be adopted for determining the same.

In step S63, the speech decryption device 5 is configured to recover a plurality of voice feature data from the converted speech data based on the shift parameter. In practice, referring to FIG. 6, the second speech analysis module 532 includes a pair of de-interpolators 64, 64′, a pair of mixer-filters 65, 65′, and an adder 66. Each of the de-interpolators 64, 64′ receives the converted speech data from the frame parser 61, and utilizes the shift parameter determined by the parameter decoder 63 to recover a plurality of voice feature data. In this embodiment, the shift parameter is the downsampling factor.

In step S64, the speech decryption device 5 is configured to synthesize the voice feature data recovered thereby so as to obtain a digital speech signal. In practice, referring to FIG. 6, each of the mixer-filters 65, 65′ of the second speech analysis module 532 filters the voice feature data recovered by a respective one of the de-interpolators 64, 64′, and shifts the voice feature data thus filtered to result in different frequency components of audio signals. The adder 66 combines the different frequency components so as to obtain the recovered digital speech signal.

It is noted that, in the first preferred embodiment, two frequency ranges (0 to 1.5 KHz, and 1.5 KHz to 3 KHz) are taken as an example for explaining the mixer-filters 321, 321′, 64, 64′. However, the human voice may be divided into more than two frequency ranges (such as N), and is not limited to two (N=2) as illustrated in this embodiment.

A second preferred embodiment of the speech encryption device 1 according to the present invention is illustrated hereinafter.

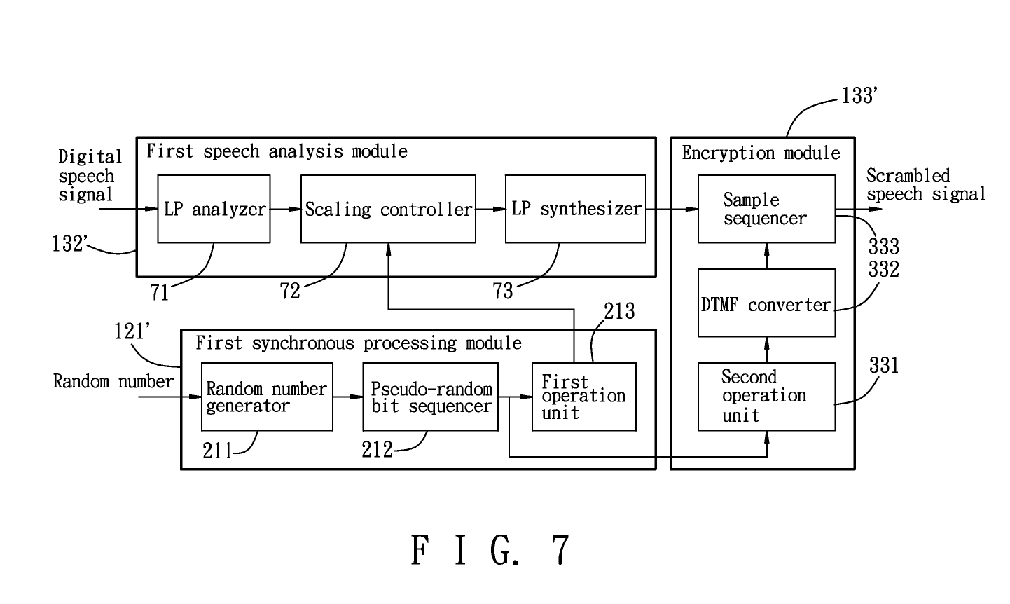

Referring to FIG. 7, operations of the first synchronous processing module 121′ and the encryption module 133′ are substantially similar to those of the first synchronous processing module 121 and the encryption module 133 of the first preferred embodiment illustrated in FIG. 3.

The second preferred embodiment differs from the first preferred embodiment in the configuration that the first speech analysis module 132′ includes a linear prediction (LP) analyzer 71, a scaling controller 72 and a LP synthesizer 73. It is noted that, similar to the first preferred embodiment, prior to the LP analyzer 71, a pre-processor (not shown) is provided for dividing the digital speech signal into a plurality of speech frames, and to form expanded speech frames from the speech frames. Since division of the digital speech signal and formation of the expanded speech frames are similar to those in the first preferred embodiment and have been explained above, details of the same are not repeated herein for the sake of brevity.

The LP analyzer 71 performs a linear predictive coding analysis on each of the expanded speech frames so as to derive the plurality of voice feature data. In this embodiment, the voice feature data are LP characteristic parameters, such as a pitch, LP coefficients, gain, linear spectral pairs (LSP), linear spectral frequencies (LSF), etc. For example, the LP coefficients are coefficients for an all-pole filter of 1/A(z), and the LSP and LSF are utilized for audio signal quantization and entropy encoding. Since these parameters may be readily appreciated by those skilled in the art, further details of the same are omitted herein for the sake of brevity.

Moreover, the scaling controller 72 scales the voice feature data based on the shift parameter. In practice, the shift parameter in this embodiment is a scale factor, and the scaling controller 72 receives the LP characteristic parameters from the LP analyzer 71, and scales each of the LP characteristic parameters based on the scale factor that changes along with variation of the encryption key. Subsequently, the LP synthesizer 73 synthesizes the voice feature data thus scaled so as to obtain the converted speech data.

The sample sequencer 333 is coupled electrically to the DTMF converter 332 and the LP synthesizer 73, receives respectively the DTMF data and the converted speech data, and interleaves the DTMF data with the converted speech data so as to output the scrambled speech signal. At this time, when the scrambled speech signal is intercepted by a third party, only an unintelligible sound of the dual-tone sounds interleaved with noise would be heard.

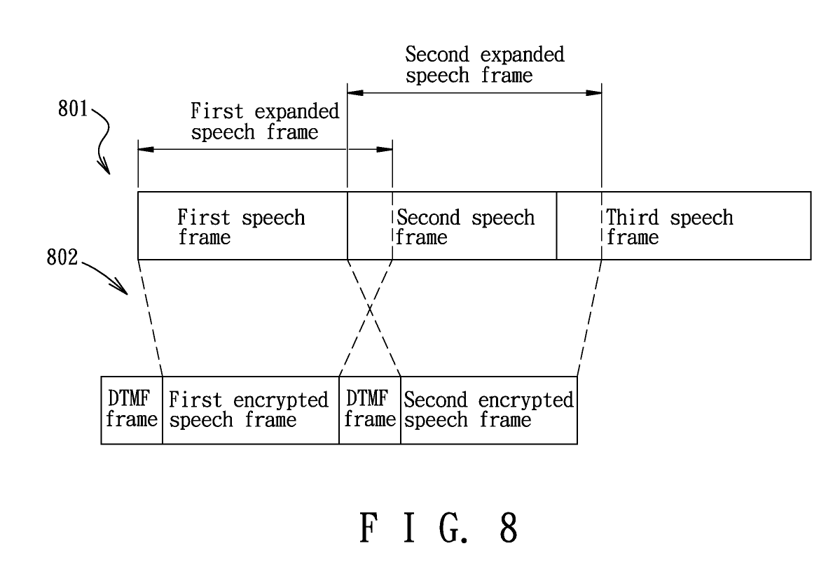

Referring to FIG. 8, each of the encrypted speech frames is added with a respective one of the DTMF frames so as to supplement the data size of the scrambled speech signal 802 such that the data size of the scrambled speech signal 802 is similar to that of the original digital speech signal 801.

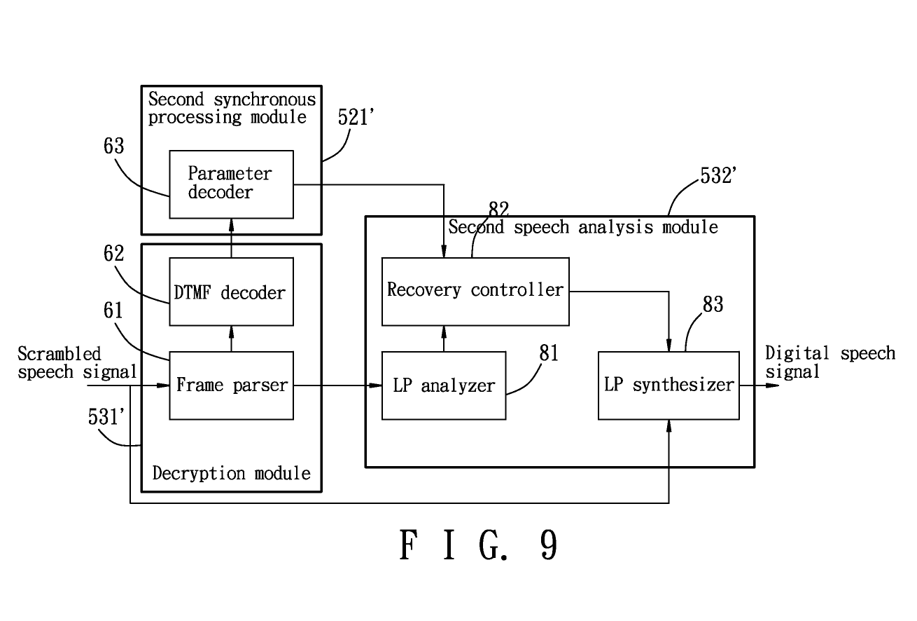

Referring to FIG. 9, a second preferred embodiment of the speech decryption device 5 corresponding to the speech encryption device 1, according to the present invention, is illustrated. Aside from the second speech analysis module 532′, internal components and operations of the decryption module 531′ and the second synchronous processing module 521′ in the second preferred embodiment are similar to those in the first preferred embodiment. Therefore, further description of the similar details is not repeated herein.

The second preferred embodiment of the speech decryption device 5 differs from the first preferred embodiment in the configurations that the second speech analysis module 532′ includes a LP analyzer 81, a recovery controller 82 and a LP synthesizer 83. The LP analyzer 81 receives the converted speech data from the frame parser 61, and performs a linear predictive coding analysis on the converted speech data so as to derive a plurality of scaled LP characteristic parameters, such as a pitch, LP coefficients, gain, LSP, LSF, etc. The recovery controller 82 de-scales the plurality of scaled LP characteristic parameters based on the shift parameter that is determined by the parameter decoder 63 so as to recover the LP characteristic parameters (i.e., the voice feature data). Finally, the LP synthesizer 83 performs a linear predictive coding synthesis on the recovered LP characteristic parameters (i.e., the voice feature data) in combination with the scrambled speech signal so as to obtain the recovered digital speech signal. Since recovery of an audio signal by utilizing relevant parameters may be readily appreciated by those skilled in the field of speech processing, further details of the same are omitted herein for the sake of brevity.

It is noted that generation of the converted speech data is not limited to the disclosures in the first and second preferred embodiments of the speech encryption device 1. The voice feature data may be converted by means of another process, such as variation by amplitude, frequency, or phase, into the converted speech data based on the shift parameter. In this way, when the speech decryption device 5 receives the scrambled speech signal, the corresponding shift parameter may be determined according to the DTMF data, and the converted speech data may be processed so as to recover the digital speech signal.

To sum up, some effects of the speech encryption method and device, and the speech decryption method and device according to the present invention are listed in the following.

1. Relatively good encryption effect: The scrambled speech signal outputted from the speech encryption device 1 includes converted speech data and DTMF data. The converted speech data is generated by means of converting the voice feature data based on the shift parameter, and the DTMF data is interleaved with the converted speech data, such that when the scrambled speech signal is intercepted, only an unintelligible sound of the dual-tone sounds interleaved with noise would be heard.

2. Relatively low system complexity: Since the encryption key is transmitted along with the converted speech data in a form of DTMF data, the speech encryption device 1 and the speech decryption device 5 only require the look-up tables or logic operations associated with the encryption key so as to determine the corresponding shift parameter for subsequent encryption and decryption processes, such that the speech security system 100 does not need complex design and may be implemented with relative ease.

3. Code-excited linear prediction (CELP) compression/decompression compatible: Since the converted speech data generated by the speech encryption method and device according to the present invention still retains speech characteristics, and the DTMF data which is interleaved with the converted speech data also conforms to audio format, CELP compression/decompression has limited influence upon audio quality of a speech signal recovered from the scrambled speech signal outputted according to the present invention.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A speech encryption method to be implemented by an encryption device for encrypting a digital speech signal, comprising the steps of:
(A) configuring the encryption device to generate an encryption key;
(B) configuring the encryption device to derive a plurality of voice feature data from the digital speech signal;
(C) configuring the encryption device to determine a corresponding shift parameter according to the encryption key generated thereby, and to convert the voice feature data derived therefrom into converted speech data based on the shift parameter; and
(D) configuring the encryption device to determine corresponding dual-tone multi-frequency (DTMF) data according to the encryption key generated thereby, and to interleave the DTMF data with the converted speech data so as to obtain a scrambled speech signal.

2. The speech encryption method as claimed in claim 1, wherein step (B) includes:
(B1) configuring the encryption device to divide the digital speech signal into a plurality of speech frames, to form expanded speech frames from the speech frames, and to derive the voice feature data from the expanded speech frames.

3. The speech encryption method as claimed in claim 2, wherein each of the expanded speech frames is formed by attaching, to a respective one of the speech frames, a segment of one of the speech frames adjacent to the respective one of the speech frames.

4. The speech encryption method as claimed in claim 2, wherein step (B1) includes:
configuring the encryption device to shift different frequency components of each of the expanded speech frames to baseband, and to filter the shifted frequency components of each of the expanded speech frames so as to derive the plurality of voice feature data.

5. The speech encryption method as claimed in claim 4, wherein the shift parameter is a downsampling factor and step (C) includes:
configuring the encryption device to downsample the voice feature data based on the shift parameter so as to obtain the converted speech data.

6. The speech encryption method as claimed in claim 2, wherein step (B1) includes:
configuring the encryption device to perform a linear predictive coding analysis on each of the expanded speech frames so as to derive the plurality of voice feature data.

7. The speech encryption method as claimed in claim 6, wherein the shift parameter is a scale factor and step (C) includes:
configuring the encryption device to scale the voice feature data based on the shift parameter and to synthesize the voice feature data thus scaled so as to obtain the converted speech data.

8. The speech encryption method as claimed in claim 1, wherein at least one of the shift parameter and the DTMF data is determined based on one of a look-up table and logic operations.

9. A speech decryption method to be implemented by a decryption device for decrypting a scrambled speech signal obtained using the speech encryption method of claim 1, comprising the steps of:
(i) configuring the decryption device to parse the scrambled speech signal into dual-tone multi-frequency (DTMF) data and converted speech data;
(ii) configuring the decryption device to determine a shift parameter according to the DTMF data;
(iii) configuring the decryption device to recover a plurality of voice feature data from the converted speech data based on the shift parameter; and
(iv) configuring the decryption device to synthesize the voice feature data recovered thereby so as to obtain a digital speech signal.

10. The speech decryption method as claimed in claim 9, wherein step (iv) includes:
configuring the decryption device to filter the voice feature data, to shift the voice feature data thus filtered to result in different frequency components, and to combine the different frequency components so as to obtain the digital speech signal.

11. The speech decryption method as claimed in claim 9, wherein step (iv) includes:
configuring the decryption device to perform a linear predictive coding synthesis on the voice feature data so as to obtain the digital speech signal.

12. A speech encryption device for encrypting a digital speech signal, comprising:
a first synchronous processing module configured to generate an encryption key, and to determine a corresponding shift parameter according to said encryption key;
a first speech analysis module coupled electrically to said first synchronous processing module, and configured to derive a plurality of voice feature data from the digital speech signal, and to convert said voice feature data into converted speech data based on said shift parameter; and
an encryption module coupled electrically to said first synchronous processing module and said first speech analysis module, and configured to determine corresponding dual-tone multi-frequency (DTMF) data according to said encryption key, and to interleave said DTMF data with said converted speech data so as to obtain a scrambled speech signal.

13. The speech encryption device as claimed in claim 12, wherein said first speech analysis module is further configured to divide the digital speech signal into a plurality of speech frames, to form expanded speech frames from said speech frames, and to derive said voice feature data from said expanded speech frames.

14. The speech encryption device as claimed in claim 13, wherein each of said expanded speech frames is formed by attaching, to a respective one of said speech frames, a segment of one of said speech frames adjacent to the respective one of said speech frames.

15. The speech encryption device as claimed in claim 13, wherein said first speech analysis module is further configured to shift different frequency components of each of said expanded speech frames to baseband, and to filter said shifted frequency components of each of said expanded speech frames so as to derive said plurality of voice feature data.

16. The speech encryption device as claimed in claim 15, wherein said shift parameter is a downsampling factor and said first speech analysis module is further configured to downsample said voice feature data based on said shift parameter so as to obtain said converted speech data.

17. The speech encryption device as claimed in claim 13, wherein said first speech analysis module is further configured to perform a linear predictive coding analysis on each of said expanded speech frames so as to derive said plurality of voice feature data.

18. The speech encryption device as claimed in claim 17, wherein said shift parameter is a scale factor and said first speech analysis module is further configured to scale said voice feature data based on said shift parameter and to synthesize said voice feature data thus scaled so as to obtain said converted speech data.

19. The speech encryption device as claimed in claim 12, wherein at least one of said shift parameter and said DTMF data is determined based on one of a look-up table and logic operations.

20. A speech decryption device for decrypting a scrambled speech signal obtained using the speech encryption device of claim 12, comprising:
a decryption module configured to parse the scrambled speech signal into dual-tone multi-frequency (DTMF) data and converted speech data;
a second synchronous processing module coupled electrically to said decryption module and configured to determine a shift parameter according to said DTMF data; and
a second speech analysis module coupled electrically to said decryption module and said second synchronous processing module, and configured to recover a plurality of voice feature data from said converted speech data based on said shift parameter, and to synthesize said voice feature data recovered thereby so as to obtain a digital speech signal.

21. The speech decryption device as claimed in claim 20, wherein said second speech analysis module is further configured to filter said voice feature data, to shift said voice feature data thus filtered to result in different frequency components, and to combine said different frequency components so as to obtain said digital speech signal.

22. The speech decryption device as claimed in claim 20, wherein said second speech analysis module is further configured to perform a linear predictive coding synthesis on said voice feature data so as to obtain said digital speech signal.
